(19) United States
(12) Patent Application Publication
(10) Pub. No.: US 2013/0257216 A1
(43) Pub. Date: Oct. 3, 2013

(54) STATOR CORE ASSEMBLY AND SPINDLE MOTOR INCLUDING THE SAME

(71) Applicants: Sang Jin Park, Suwon (KR); Gun Hee Jang, Seoul (KR); Sang Jin Sung, Seoul (KR); Ju Ho Kim, Suwon (KR)

(72) Inventors: Sang Jin Park, Suwon (KR); Gun Hee Jang, Seoul (KR); Sang Jin Sung, Seoul (KR); Ju Ho Kim, Suwon (KR)

(73) Assignees: IUCF-HYU (Industry-University Cooperation Foundation Hanyang University), Seoul (KR); Samsung Electro-Mechanics Co., Ltd., Suwon (KR)

(21) Appl. No.: 13/598,139

(22) Filed: Aug. 29, 2012

(30) Foreign Application Priority Data
Mar. 28, 2012 (KR) 10-2012-0031579

(51) Int. Cl. H02K 3/28

(52) U.S. Cl. 310/208

(57) ABSTRACT

There is provided a stator core assembly including: a body having a circular ring shape; a teeth part including a plurality of teeth extended from the body; and a plurality of coils wound around the plurality of teeth, wherein the coils are wound n+3k times around any one of the plurality of teeth and wound n times around the remaining teeth.

### CROSS-REFERENCE TO RELATED APPLICATIONS

This application claims the priority of Korean Patent Application No. 10-2012-0031579 filed on Mar. 28, 2012, in the Korean Intellectual Property Office, the disclosure of which is incorporated herein by reference.

### BACKGROUND OF THE INVENTION

1. Field of the Invention

The present invention relates to a stator core assembly and a spindle motor including the same.

2. Description of the Related Art

Generally, a three-phase brushless motor is used in a hard disk drive. A three-phase brushless motor includes a rotor using a shaft, a rotating member, as an axis, and a stator rotatably supporting the rotor.

In addition, the rotor may have a magnet in which S and N poles are alternately magnetized in a circumferential direction.

Further, the stator may include an annular stator core formed by stacking several thin metal plates, and the stator core may include a plurality of teeth protruded in a radial direction at each phase position in the circumferential direction. Further, slots are formed by the plurality of teeth having coils wound therearound and corresponding thereto.

In addition, when a variable frequency three-phase motor current such as a sinusoidal wave current or a square wave current is supplied to the coils, the rotor rotates, such that the brushless motor is driven.

However, the occurrence of cogging torque, in which torque may pulsate due to non-uniformity in the strength of an electro-magnetic field generated by the plurality of teeth or the slots of the stator core while interacting with the magnet, may be problematic.

In order to prevent the occurrence of this cogging torque, several technologies regarding the shape of a magnetic pole of the rotor provided in the brushless motor, the shape of the plurality of teeth of the stator core provided therein, a method of winding the coil, or the like, have been developed to be optimized.

Meanwhile, the coils may be wound around the plurality of teeth of the stator core, the plurality of teeth having three intervals therebetween. Therefore, there is a need to wind the coils appropriately, such that a skip line passing through adjacent coil points to one another may not be loose.

In the case in which the coils are wound with this winding scheme, a phenomenon in which the coils wound around the plurality of teeth become loose may be suppressed. However, in this case, the pulsation of torque may not be suppressed.

That is, the development of a technology for a coil winding method capable of reducing the pulsation of torque, while suppressing the wound coil from being loose has been in demand.

### RELATED ART DOCUMENT

(Patent Document 1) Japanese Patent Laid-Open Publication No. 2008-061331

### SUMMARY OF THE INVENTION

An aspect of the present invention provides a stator core assembly capable of reducing non-uniformity in electromagnetic force, the generation of vibrations and noise, and variations in a rotation speed, and a spindle motor including the same.

According to an aspect of the present invention, there is provided a stator core assembly including: a body having a circular ring shape; a teeth part including a plurality of teeth extended from the body; and a plurality of coils wound around the plurality of teeth, wherein the coils are wound n+3k times around any one of the plurality of teeth and wound n times around the remaining teeth.

The teeth part may include first to third teeth parts, each of which includes at least one or more teeth.

The plurality of coils may include a first coil wound around the teeth of the first teeth part; a second coil wound around the teeth of the second teeth part; and a third coil wound around the teeth of the third teeth part.

The first coil may be wound n times around the teeth of the first teeth part and then wound k times around any one tooth of the second teeth part before being led toward a base member.

The second coil may be wound n times around the teeth of the second teeth part, wound n+k times around the tooth of the second teeth part having the first coil wound therearound, and then led toward the base member.

The third coil may be wound n times around the teeth of the third teeth part, wound k times around the tooth of the second teeth part having the first coil wound therearound, and then led toward the base member.

According to another aspect of the present invention, there is provided a spindle motor including: a base member including an installation part having a sleeve insertedly installed therein; a stator core assembly fixedly installed on the installation part; and a rotor hub rotatably supported by the sleeve and rotating together with a shaft, wherein the stator core assembly includes: a body having a circular ring shape; a teeth part including a plurality of teeth extended from the body; and a plurality of coils wound around the plurality of teeth, wherein the coils are wound n+3k times around any one of the plurality of teeth and wound n times around the remaining teeth.

The teeth part may include first to third teeth parts, each of which includes at least one or more teeth, and the plurality of coils may include a first coil wound around the teeth of the first teeth part; a second coil wound around the teeth of the second teeth part; and a third coil wound around the teeth of the third teeth part.

The base member may have a lead hole disposed to be adjacent to the installation part and allowing the first to third coils to be led downwardly.

The first coil may be wound n times around the teeth of the first teeth part and then wound k times around any one tooth of the second teeth part before being led toward the base member.

The second coil may be wound n times around the teeth of the second teeth part, wound n+k times around the tooth of the second teeth part having the first coil wound therearound, and then led toward the base member.

The third coil may be wound n times around the teeth of the third teeth part, wound k times around the tooth of the second teeth part having the first coil wound therearound, and then led toward the base member.

The rotor hub may have a driving magnet disposed on an inner surface thereof, the driving magnet being disposed to face front ends of the first to third teeth parts.

The driving magnet may have nine N poles and nine S poles alternately magnetized in a circumferential direction, and each of the first to third teeth parts may include three teeth.

### BRIEF DESCRIPTION OF THE DRAWINGS

The above and other aspects, features and advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is an exploded perspective view showing a stator core assembly and a base member according to the embodiment of the present invention; and

FIGS. 3 through 5 are views describing a method of winding a coil around a stator core of the stator core assembly.

### DETAILED DESCRIPTION OF THE INVENTION

Embodiments of the present invention will now be described in detail with reference to the accompanying drawings. However, it should be noted that the present invention is not limited to the embodiments set forth herein, and those skilled in the art and understanding the present invention could easily accomplish retrogressive inventions or other embodiments included in the scope of the present invention by the addition, modification, and removal of components within the same spirit, but those are to be construed as being included in the spirit of the present invention.

Further, when a detailed description of related known functions or constitution is considered to unnecessarily obscure the gist of the present invention, the detailed description thereof will be omitted.

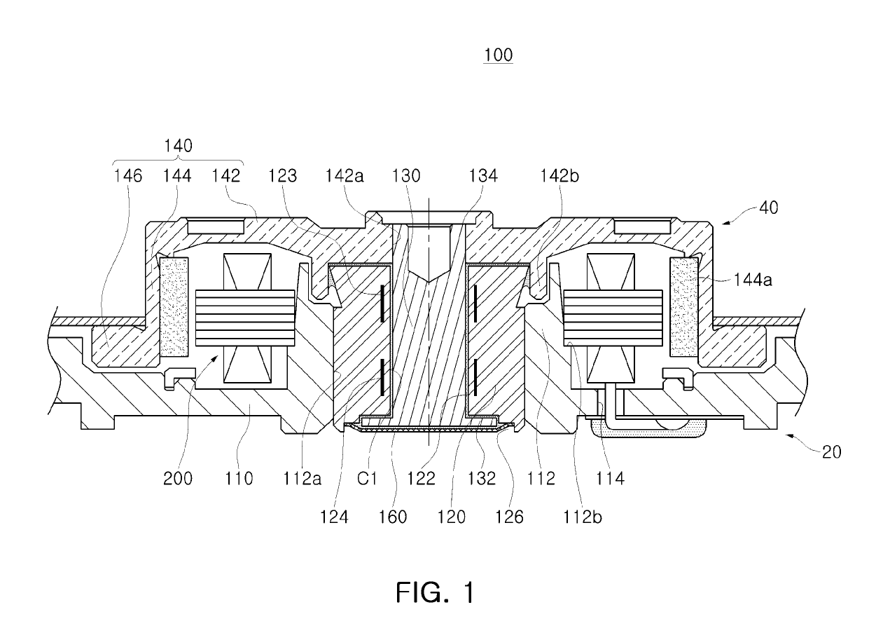

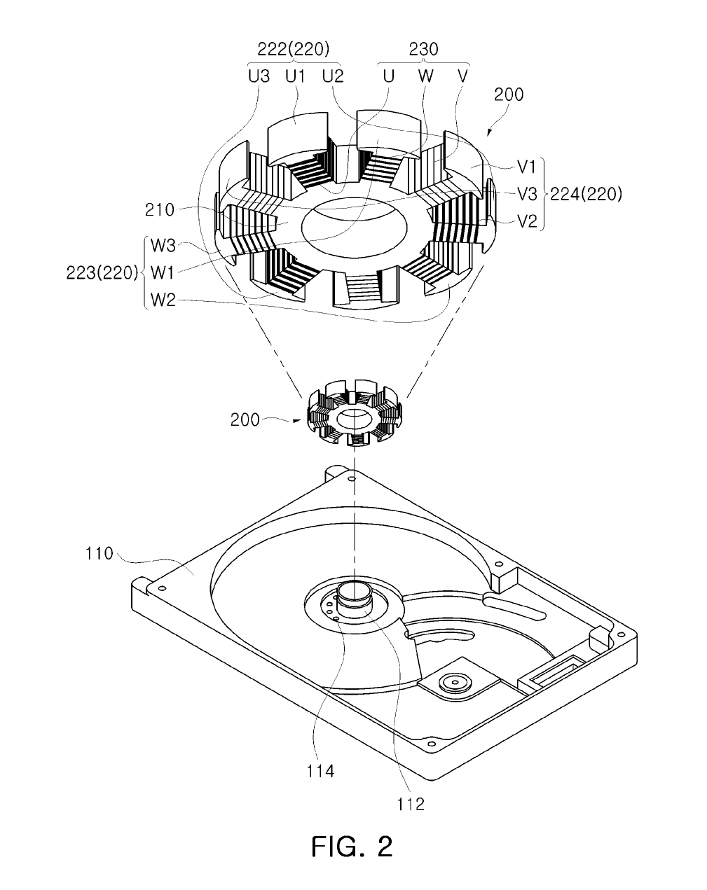

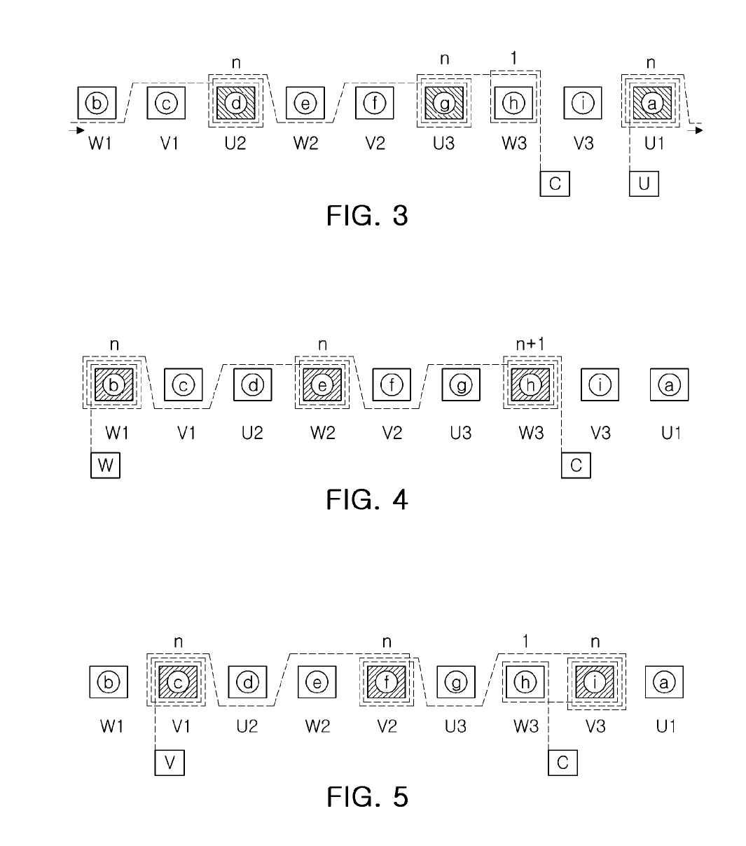

FIG. 1 is a schematic cross-sectional view showing a spindle motor according to an embodiment of the present invention; FIG. 2 is an exploded perspective view showing a stator core assembly and a base member according to the embodiment of the present invention; and FIGS. 3 through 5 are views describing a method of winding a coil around a stator core of the stator core assembly.

Referring to FIGS. 1 through 5, a spindle motor 100 according to an embodiment of the present invention may include a base member 110, a sleeve 120, a shaft 130, a rotor hub 140, and a stator core assembly 200.

The spindle motor 100 may be a motor used in a recording disk drive device driving a recording disk.

Here, terms with respect to directions will be defined. As viewed in FIG. 1, an axial direction refers to a vertical direction, that is, a direction from a lower portion of the shaft 130 toward an upper portion thereof or a direction from the upper portion of the shaft 130 toward the lower portion thereof, and a radial direction refers to a horizontal direction, that is, a direction from an outer peripheral surface of the rotor hub 140 toward the shaft 130 or from the shaft 130 toward the outer peripheral surface of the rotor hub 140.

In addition, a circumferential direction refers to a rotation direction along an outer circumference of the rotor hub 140 or the shaft 130.

The base member 110, a fixed member, may configure a stator 20. Here, the stator 20, referring to all fixed members with the exception of rotating members, may include the base member 110, the sleeve 120, and the like.

In addition, the base member 110 may include an installation part 112 having the sleeve 120 insertedly installed therein. The installation part 112 may be protruded upwardly in an axial direction and include an installation hole 112a formed therein so that the sleeve 120 may be insertedly installed therein.

In addition, the installation part 112 may include a seat surface 112b formed on an outer peripheral surface thereof so that the stator core assembly 200 may be seated thereon. That is, the stator core assembly 200 may be fixedly installed on the outer peripheral surface of the installation part 112 by an adhesive in a state in which it is seated on the seat surface 112b.

However, the stator core assembly 200 may also be installed on the outer peripheral surface of the installation part 112 in a press-fitting scheme without using an adhesive. That is, a scheme of installing the stator core assembly 200 is not limited to an adhesive scheme.

In addition, the base member 110 may include a lead hole 114 formed to be disposed in the vicinity of the installation part 112. A plurality of lead holes 114 may be provided. For example, four lead holes 114 may be formed in the vicinity of the installation part 112.

A detailed description of the lead hole 114 will be provided below.

The sleeve 120, a fixed member configuring the stator 20 together with the base member 110, may rotatably support the shaft 130 and form a bearing clearance C1 filled with a lubricating fluid.

Meanwhile, the sleeve 120 may be inserted into and fixedly installed in the installation part 112 of the base member 110 as described above. That is, an outer peripheral surface of the sleeve 120 may be adhered to an inner peripheral surface of the installation part 112 by an adhesive.

Further, the sleeve 120 may include a shaft hole 122 formed therein, the shaft hole 132 having the shaft 130 inserted thereinto. Further, in the case in which the shaft 130 is inserted into the shaft hole 120 of the sleeve 122, an inner peripheral surface of the sleeve 120 and the outer peripheral surface of the shaft 130 may be spaced apart from each other by a predetermined interval to thereby form the bearing clearance C1 therebetween.

In addition, the sleeve 120 may include upper and lower radial dynamic pressure grooves 123 and 124 formed in an inner peripheral surface thereof in order to generate fluid dynamic pressure at the time of rotational driving of the shaft 130. Further, the upper and lower radial dynamic pressure grooves 123 and 124 may be spaced apart from each other by a predetermined interval and have a herringbone or spiral shape.

However, the above-mentioned upper and lower radial dynamic pressure grooves 123 and 124 are not limited to being formed in the inner peripheral surface of the sleeve 120, but may also be formed in the outer peripheral surface of the shaft 130.

Meanwhile, the sleeve 120 may include amounting groove 126 formed in a lower end portion thereof so that the cover member 160 may be installed therein.

The shaft 130, a rotating member, may configure a rotor 40. Here, the rotor 40 refers to a member rotatably supported by the stator 20 to rotate.

Meanwhile, the shaft 130 may be rotatably supported by the sleeve 120. In addition, the shaft 130 may have a flange part 132 provided on a lower end portion thereof.

The flange part 132 may serve to prevent excessive floating of the shaft 130 while simultaneously preventing the shaft 130 from being separated from the sleeve 120 in an upward direction. That is, the shaft 130 may be floated by a predetermined interval at the time of the rotational driving thereof. The flange part 132 may prevent the shaft 130 from being excessively floated when the shaft 130 is floated. In addition, the flange part 132 may serve to prevent the shaft 130 from being separated from the sleeve 120 in an upward direction, due to external impacts.

In addition, the shaft 130 may include a coupling part 134 formed on an upper end portion thereof, and the coupling part 134 may be coupled to the rotor hub 140. Further, the coupling part 134 may be protruded upwardly of the sleeve 120 in the case in which the shaft 130 is installed in the sleeve 120.

The rotor hub 140, a rotating member configuring the rotor 40 together with the shaft 140, may be fixedly installed on the upper end portion of the shaft 130 and rotate together with the shaft 130.

Meanwhile, the rotor hub 140 may include a rotor hub body 142 having a mounting hole 142a into which the coupling part 134 of the shaft 130 is inserted, a magnet mounting part 144 extended from an edge of the rotor hub body 142 in a downward axial direction, and a disk seat part 146 extended from a distal end of the magnet mounting part 144 in the outer diameter direction.

In addition, the magnet mounting part 144 may have a driving magnet 144a installed on an inner surface thereof, and the driving magnet 144a is disposed to face a front end of the stator core assembly 200.

Meanwhile, the driving magnet 144a may have an annular ring shape and be a permanent magnet generating magnetic force having a predetermined strength by alternately magnetizing N and S poles in the circumferential direction.

Here, the rotational driving of the rotor hub 140 will be described. When power is supplied to a coil 230 provided in the stator core assembly 200, to be described below, driving force capable of rotating the rotor hub 140 may be generated by electromagnetic interaction between the driving magnet 144a and the stator core assembly 200 having the coil 230 wound therearound.

Therefore, the rotor hub 140 may rotate. In addition, the shaft 130 on which the rotor hub 140 is fixedly installed may rotate together with the rotor hub 140 by the rotation of the rotor hub 140.

Meanwhile, the rotor hub body 142 may include an extension wall part 142b extended in the downward axial direction, and the external wall part 142b together with the outer peripheral surface of the sleeve 120 may form an interface between the lubricating fluid and air, that is, a liquid-vapor interface, therebetween.

An inner surface of the extension wall part 142b may be disposed to face the outer peripheral surface of the sleeve 120, and at least one of the outer peripheral surface of the sleeve 120 and the inner surface of the extension wall part 142b may be inclined so as to form the liquid-vapor interface.

That is, at least one of the outer peripheral surface of the sleeve 120 and the inner surface of the extension wall part 142b may be inclined so as to form the liquid-vapor interface through a capillary phenomenon.

Meanwhile, in the case in which both of the inner surface of the extension wall part 142b and the outer peripheral surface of the sleeve 120 are inclined, angles of inclination thereof may be different.

The stator core assembly 200 may be fixedly installed on an outer peripheral surface of the installation part 112 of the base member 110 and disposed to face the driving magnet 144a as described above.

For example, the stator core assembly 200 may include a body 210, a teeth part 220, and a coil 230, as shown in FIG. 2.

The body 210 may have a circular ring shape. That is, the body 210 may include a hole through which the installation part 112 penetrates and may have a plate shape.

Meanwhile, the teeth part 220 may be extended from an outer peripheral surface of the body 120 and include a plurality of teeth U1, U2, U3, W1, W2, W3, V1, V2, and V3.

In addition, the teeth part 220 may include first to third teeth parts 222 to 224 respectively including at least one tooth. That is, for example, the first teeth part 222 may include three teeth U1, U2, and U3, the second teeth part 223 may include three teeth W1, W2, and W3, and the third teeth part 224 may include three teeth V1, V2, and V3.

The plurality of teeth U1, U2, U3, W1, W2, W3, V1, V2, and V3 configuring the first teeth part 222, the second teeth part 223, and the third teeth part 224 may be sequentially disposed in the circumferential direction.

The coil 230 may be wound n times around the above-mentioned teeth U1, U2, U3, W1, W2, W3, V1, V2, and V3. In addition, the coil 230 may include a first coil U wound around the plurality of teeth U1, U2, and U3 configuring the first teeth part 222, a second coil W wound around the plurality of teeth W1, W2, and W3 configuring the second teeth part 223, and a third coil V wound around the plurality of teeth V1, V2, and V3 configuring the third teeth part 223.

Meanwhile, the coil 230 may be wound n+3k times around any one of the plurality of teeth U1, U2, U3, W1, W2, W3, V1, V2, and V3 and be wound n times around remaining teeth. Here, k, which indicates an integer, may be 1, 2, 3, 4, or the like.

Hereinafter, a method of winding the coil 230 will be described in more detail with reference to FIGS. 3 through 5.

First, as shown in FIG. 3, the first coil U is led from a lower portion of the tooth U1 included in the first teeth part 222 to an upper portion thereof and then wound n times in a clockwise direction. Then, the first coil U passes through a lower portion of the tooth W1 included in the second teeth part 223, is led upwardly between the tooth W1 included in the second teeth part 223 and the tooth V1 included in the third teeth part 224, and then passes through an upper portion of the tooth V1 included in the third teeth part 224.

Thereafter, the first coil U is wound n times around the tooth U2 included in the first teeth part 222 in the clockwise direction.

As described above, the first coil U is wound, whereby a phenomenon in which the first coil U is undone or loosely wound around the plurality of teeth U1, U2, and U3 may be reduced. That is, since the first coil U is wound so as to pass through the plurality of teeth W1 and V1 around which it is not wound in a zigzag form, the first coil U may not be undone or loosely wound.

Then, the first coil U passes through the tooth W2 included in the second teeth part 223 and the tooth V2 included in the third teeth part 224. Here, the first coil may pass through the plurality of teeth W2 and V2 in a zigzag form.

Thereafter, the first coil U is wound n times around the tooth U3 included in the first teeth part 222 in the clockwise direction.

The first coil U wound n times around each of the plurality of teeth U1, U2, and U3 included in the first teeth part 222 as described above is then led toward the base member 110. Meanwhile, before the first coil U is led toward the base member 110, the first coil U may be wound k times (here, k indicates an integer, for example, k=1) around the tooth W3 included in the second teeth part 224 in the clockwise direction and then led toward the base member 110.

In addition, a rear end portion of the first coil U led toward the base member 110 is bound together with the second and third coils and then led to a lower portion of the base member 110. Generally, a lead part C disposed at each of rear end portions of the first to third coils U, W, and V is called a common line.

Further, the lead part C of the first coil U is led toward the base member 110 through a space between the tooth W3 included in the second teeth part 223 and the tooth V3 included in the third teeth part 224.

Next, a method of winding the second coil W will be described with reference to FIG. 4.

First, the second coil W is led upwardly from the base member 110 and then wound n times around the tooth W1 included in the second teeth part 223 in the clockwise direction.

Then, the second coil W wound around the tooth W1 included in the second teeth part 223 passes through the tooth V1 included in the third teeth part 224 and the tooth U2 included in the first teeth part 222. Here, the second coil W passes through a lower portion of the tooth V1 included in the third teeth part 224 and an upper portion of the tooth U2 included in the first teeth part 222.

Thereafter, the second coil W is wound n times around the tooth W2 included in the second teeth part 223 in the clockwise direction.

Then, the second coil W passes through the tooth V2 included in the third teeth part 224 and the tooth U3 included in the first teeth part 222 in the same scheme as the above-mentioned scheme.

The second coil W passing through the tooth U3 included in the first teeth part 222 is wound n+k times (here, k indicates an integer, for example, k=1) around the tooth W3 included in the second teeth part 223 in the clockwise direction and then led toward the base member 110.

Further, the lead part C of the second coil W is led toward the base member 110 through a space between the tooth W3 included in the second teeth part 223 and the tooth V3 included in the third teeth part 224.

Finally, a method of winding the third coil V will be described with reference to FIG. 5.

First, the third coil V is led upwardly from the base member 110 and then wound n times around the tooth V1 included in the third teeth part 224 in the clockwise direction.

Then, the third coil V wound around the tooth V1 included in the third teeth part 224 passes through the tooth U2 included in the first teeth part 222 and the tooth W2 included in the second teeth part 223. Here, the third coil V passes through a lower portion of the tooth U2 included in the first teeth part 222 and an upper portion of the tooth W2 included in the second teeth part 223.

Thereafter, the third coil V is wound n times around the tooth V2 included in the third teeth part 224 in the clockwise direction.

Then, the third coil V passes through the tooth U3 included in the first teeth part 222 and the teeth W3 included in the second teeth part 223 in the same scheme as the above-mentioned scheme.

The third coil V passing through the tooth W3 included in the second teeth part 223 is wound n times around the tooth V3 included in the third teeth part 224 in the clockwise direction.

Thereafter, the third coil V is wound k times (here, k indicates an integer, for example, k=1) around the tooth W3 included in the second teeth part 223 in the clockwise direction.

Further, the lead part C of the third coil V is led toward the base member 110 through a space between the tooth W3 included in the second teeth part 223 and the tooth V3 included in the third teeth part 224.

As described above, since the first to third coils U, W, and V are wound around the first to third teeth parts 222 to 224, non-uniformity of electromagnetic force may be reduced. Therefore, vibrations and noise may be reduced. Further, repeatable run out (RRO) generated in a rotor due to non-uniform magnetic force may be reduced.

Hereinafter, a detailed description thereof will be provided.

First, describing a flow of current in the first to third coils U, W, and V, the current flows only in two of the first to third coils U, W, and V and does not flow in the remaining coil.

First, in the case in which the current flows in the first and second coils U and W, it does not flow in the third coil V. In addition, when positive (+) current flows in the first coil U, negative (−) current flows in the second coil W.

In this case, the current flowing through the first coil U flows in a direction (a clockwise direction) in which the first coil U is wound, and the current flowing through the second coil W flows in a direction (that is, in a counterclockwise direction) opposite to the direction in which the second coil W is wound.

Meanwhile, as described above, the first coil U is wound k times (here, k indicates an integer, for example, k=1) and the second coil V is wound n+k times (here, k indicates an integer, for example, k=1), around the tooth W3 included in the second teeth part 223. Therefore, the generation of magnetic force by k-times winding of the first coil U may be offset by the generation of magnetic force by additional k-times winding of the second coil W.

That is, the magnetic force by the k-times (here, k indicates an integer, for example, k=1) winding of the first coil U wound around the tooth W3 included in the second teeth part 223 may be offset by the magnetic force by additional k-times winding (here, k indicates an integer, for example, k=1) of the second coil W wound around the tooth W3 included in the second teeth part 223.

The reason for which the magnetic force is offset is that the magnetic force is generated in a direction in which the current flows according to the Fleming's right-hand rule, and a direction of the current flowing through the first coil U and a direction of the current flowing through the second coil W are opposite to one another.

Alternately, in the case in which the positive (+) current flows in the second coil W and the negative (−) current flows in the first coil U, magnetic force may be offset due to the above-described principle.

In addition, in the case in which current flows in the first and third coils U and V, it does not flow in the second coil W. In addition, when positive (+) current flows in the first coil U, negative (−) current flows in the third coil V.

In this case, the current flowing through the first coil U flows in a direction (in a clockwise direction) in which the first coil U is wound, and the current flowing through the third coil V flows in a direction (that is, in a counterclockwise direction) opposite to the direction in which the third coil V is wound.

Meanwhile, as described above, the first coil U is wound k times (here, k indicates an integer, for example, k=1) and the third coil V is wound k times (here, k indicates an integer, for example, k=1), around the tooth W3 included in the second teeth part 223. Therefore, the generation of magnetic force by k-times winding of the first coil U may be offset by the generation of magnetic force by k-times winding of the third coil V.

To the contrary, in the case in which the positive (+) current flows in the third coil V and the negative (−) current flows in the first coil U, the magnetic force may be offset due to the above-described principle.

In the case in which current flows in the second and third coils W and V, it does not flow in the first coil U. In addition, when positive (+) current flows in the second coil W, negative (−) current flows in the third coil V.

In this case, the current flowing through the second coil W flows in a direction (in a clockwise direction) in which the second coil W is wound, and the current flowing through the third coil V flows in a direction (that is, in a counterclockwise direction) opposite to the direction in which the third coil V is wound.

Therefore, magnetic force generated by k-times (here, k indicates an integer, for example, k=1) winding of the coils W and V additionally wound around the tooth W3 included in the second teeth part 223 may be offset.

Alternatively, in the case in which the positive (+) current flows in the third coil V and the negative (−) current flows in the second coil W, the magnetic force may be offset due to the above-described principle.

As described above, since the first to third coils U, W, and V are additionally wound k times around any one tooth included in the second teeth part 223, a phenomenon in which inductance is additionally generated by the lead part C at the time of driving may be suppressed.

Therefore, non-uniformity in electromagnetic force may be reduced. Therefore, vibrations and noise may be reduced. Further, repeatable run out (RRO) of a rotor generated due to non-uniform magnetic force may be reduced.

As set forth above, since the first to third coils are additionally wound k times around any one of teeth included in the second teeth part, a phenomenon in which inductance is additionally generated by the lead part at the time of the driving may be suppressed.

Therefore, the non-uniformity of the electromagnetic force may be reduced. As a result, the generation of vibrations and noise due to the non-uniformity of the electromagnetic force may be reduced, and the deterioration of rotational characteristics generated due to non-uniform magnetic force (that is, the generation of RRO) may be reduced.

While the present invention has been shown and described in connection with the embodiments, it will be apparent to those skilled in the art that modifications and variations can be made without departing from the spirit and scope of the invention as defined by the appended claims.

What is claimed is:

1. A stator core assembly comprising:
a body having a circular ring shape;
a teeth part including a plurality of teeth extended from the body; and
a plurality of coils wound around the plurality of teeth,
wherein the coils are wound n+3k times around any one of the plurality of teeth and wound n times around the remaining teeth.

2. The stator core assembly of claim 1, wherein the teeth part comprises first to third teeth parts, each of which includes at least one or more teeth.

3. The stator core assembly of claim 2, wherein the plurality of coils comprise:
a first coil wound around the teeth of the first teeth part;
a second coil wound around the teeth of the second teeth part; and
a third coil wound around the teeth of the third teeth part.

4. The stator core assembly of claim 3, wherein the first coil is wound n times around the teeth of the first teeth part and then wound k times around any one tooth of the second teeth part before being led toward a base member,
the second coil is wound n times around the teeth of the second teeth part, wound n+k times around the tooth of the second teeth part having the first coil wound therearound, and then led toward the base member, and
the third coil is wound n times around the teeth of the third teeth part, wound k times around the tooth of the second teeth part having the first coil wound therearound, and then led toward the base member.

5. A spindle motor comprising:
a base member including an installation part having a sleeve insertedly installed therein;
a stator core assembly fixedly installed on the installation part; and
a rotor hub rotatably supported by the sleeve and rotating together with a shaft,
wherein the stator core assembly includes:
a body having a circular ring shape;
a teeth part including a plurality of teeth extended from the body; and
a plurality of coils wound around the plurality of teeth,
wherein the coils are wound n+3k times around any one of the plurality of teeth and wound n times around the remaining teeth.

6. The spindle motor of claim 5, wherein the teeth part comprises first to third teeth parts, each of which includes at least one or more teeth, and
the plurality of coils comprise:
a first coil wound around the teeth of the first teeth part;
a second coil wound around the teeth of the second teeth part; and
a third coil wound around the teeth of the third teeth part.

7. The spindle motor of claim 6, wherein the base member has a lead hole disposed to be adjacent to the installation part and allowing the first to third coils to be led downwardly.

8. The spindle motor of claim 6, wherein the first coil is wound n times around the teeth of the first teeth part and then wound k times around any one tooth of the second teeth part before being led toward the base member,
the second coil is wound n times around the teeth of the second teeth part, wound n+k times around the tooth of the second teeth part having the first coil wound therearound, and then led toward the base member, and
the third coil is wound n times around the teeth of the third teeth part, wound k times around the tooth of the second teeth part having the first coil wound therearound, and then led toward the base member.

9. The spindle motor of claim 8, wherein the rotor hub has a driving magnet disposed on an inner surface thereof, the driving magnet being disposed to face front ends of the first to third teeth parts.

10. The spindle motor of claim 9, wherein the driving magnet has nine N poles and nine S poles alternately magnetized in a circumferential direction, and
each of the first to third teeth parts includes three teeth.
